(19) United States
(12) Patent Application Publication
(10) Pub. No.: US 2007/0140054 A1
(43) Pub. Date: Jun. 21, 2007

(54) Quick-disconnect mixer drive system

(76) Inventor: Stephen Dale Stocker, Centerville, OH (US)

Correspondence Address: THOMPSON HINE L.L.P., P.O. BOX 8801, DAYTON, OH, 45401-8801, US

(21) Appl. No.: 11/303,416

(22) Filed: Dec. 16, 2005

(51) Int. Cl. B01F 7/16; B01F 15/00

(52) U.S. Cl. 366/331

(57) ABSTRACT

A quick-disconnect mixer drive system includes a drive adapted to be mounted on a mixing tank. The drive includes an output shaft; a first quick-disconnect coupling component mounted on the output shaft; and a second quick-disconnect coupling component adapted to be mounted on a mixing shaft of an associated mixing tank. The second quick-disconnect coupling component being shaped to engage the first quick-disconnect coupling component to transmit both clockwise and counterclockwise torque from the output shaft to the mixing shaft and resist relative longitudinal movement between the first and second quick-disconnect coupling components.

### BACKGROUND

This disclosure relates to portable mixers and, more particularly, to quick-disconnect mixer drive systems adapted to be mounted on mixing tanks.

Large volume users of paint, such as automotive assembly plants, typically purchase paint in large, substantially enclosed, stainless steel drums called “totes.” Totes typically include internal mixing blades attached to a vertical shaft that is rotatably mounted to the tote. The shaft may include a stub portion that protrudes upwardly from a top surface of the tote. A drive may be mounted (or otherwise positioned) on the top of the tote and may engage the stub portion so that the drive rotates the shaft supporting the mixing blades.

The totes typically are recycled; that is, they are repeatedly filled with paint and emptied as the paint is sprayed onto vehicles by various paint spraying devices. The mixing blades are rotated to ensure that the paint is properly mixed as it is being used. The need for cleaning a tote after it has been drained of paint may be eliminated by keeping the shaft and impeller system captive to the tank and refilling the tank with the same material.

Painting facilities may store and use many totes at any one time. However, such facilities typically only have a few drives. Therefore, the agitator drives may be mounted on the totes being used, thereby requiring the user to connect and disconnect the drives from the totes as the totes are rotated through the facility. This technique minimizes the number of drive systems required and reduces the overall cost of producing the end product.

Consequently, there is a need for a mixer drive system that may be quickly and easily attached to and removed from a tote.

### SUMMARY

In one aspect, a quick-disconnect mixer drive system may include a drive adapted to be mounted on a mixing tank. The drive may include an output shaft, a first quick-disconnect coupling component mounted on the output shaft and a second quick-disconnect coupling component adapted to be mounted on a mixing shaft of an associated mixing tank. The second quick-disconnect coupling component may be shaped to engage the first quick-disconnect coupling component to transmit both clockwise and counter-clockwise torque from the output shaft to the mixing shaft and resist relative longitudinal movement between the first and second quick-disconnect coupling components.

Other aspects will become apparent from the following description, the accompanying drawings and the appended claims.

### BRIEF DESCRIPTION OF THE DRAWINGS

FIG. 1 is a front elevational view, partially in section, of an aspect of the quick-disconnect mixer drive system;

FIG. 2 is a perspective view of the plug quick-disconnect coupling component of FIG. 1;

FIG. 3 is an exploded, side elevational view, in section, of the socket quick-disconnect coupling component of FIG. 1; and

FIG. 4 is a side elevational view, in section, of the socket quick-disconnect coupling component of FIG. 3.

### DETAILED DESCRIPTION

As used herein, “quick-disconnect” shall refer generally to any connector adapted to facilitate rapid engagement and disengagement of two connector halves.

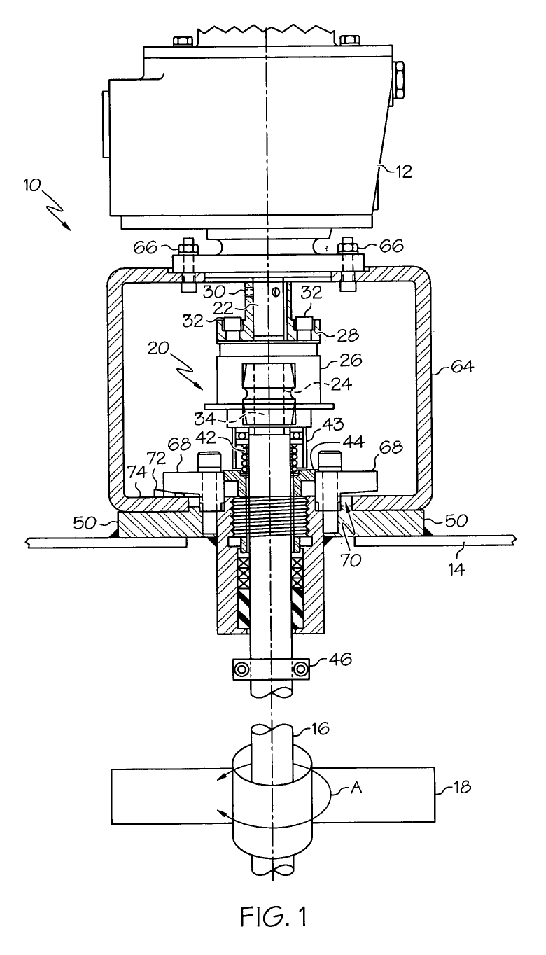

As shown in FIG. 1, a quick-disconnect mixer drive system, generally designated 10, may include a drive 12 adapted to be mounted on a tote 14 having a mixing shaft 16 positioned therein. The mixing shaft 16 may include mixing blades 18 or other agitating devices mounted thereon.

The drive 12 may be operatively connected to the mixing shaft 16 by a quick-disconnect 20 such that the drive 12 may supply clockwise or counter-clockwise rotational torque to the mixing shaft 16, as shown by arrow A. In one aspect, the drive 12 may be a motor or the like and may include an output shaft 22, wherein the output shaft 22 may be operatively connected to the mixing shaft 16 by the quick-disconnect 20.

In one aspect, the quick-disconnect 20 may include a plug portion 24 and a socket portion 26. The output shaft 22 may be connected to a quick-disconnect adapter 28 by a set screw 30 and the adapter 28 may be connected to the socket portion 26 of the quick-disconnect 20 by screws 32, such that clockwise and counter-clockwise torque may be transferred from the output shaft 22 of the drive 12 to the socket portion 26 and plug portion 24 of the quick-disconnect 20 and ultimately to the mixing shaft 16.

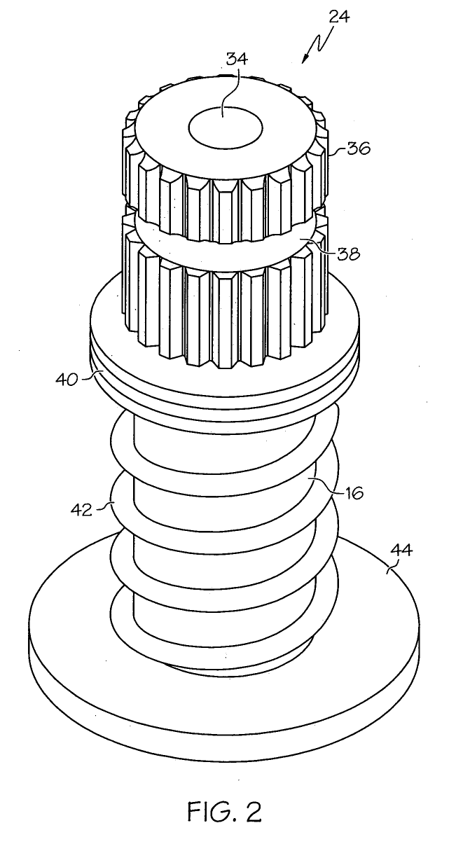

As shown in FIG. 2, the plug portion 24 may be connected to a stud portion 34 of the mixing shaft 16 that protrudes above the tote 14. In one aspect, the plug portion 24 may be press fit onto the stud portion 34, although any connection means may be used.

In one aspect, the plug portion 24 may include a plurality of longitudinal splines 36 and a circumferential race 38. A thrust bearing 40 may be shaped to slidably engage the mixing shaft 16 and may be urged against the underside of the plug portion 24 by a coil spring 42, thereby urging the plug portion 24 away from the tote 14. The coil spring 42 may be seated on a packing follower 44, as shown in FIG. 1, and may urge the plug portion 24 away from the tote 14. A collar 46 (FIG. 1) may be mounted on the mixing shaft 16 to restrict the travel of the mixing shaft 12 relative to the packing follower 44 beyond a predetermined point.

As shown in FIG. 1, a protective cover 43 may be positioned over the thrust bearing 40 and or the spring 42. The cover 43 may be made from a plastisol, a rubber material, a metal or metal alloy, a polymeric material or the like.

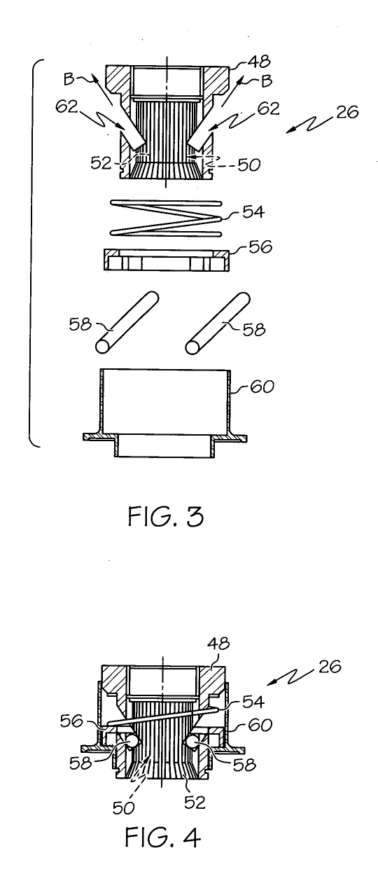

As shown in FIGS. 3 and 4, the socket portion 26 may include a body 48 that defines a socket 50 therein. The socket 50 may include a plurality of grooves 52 sized and shaped to receive the splines 36 (see FIG. 2) when the plug portion 24 is received within the socket 50 of the socket portion 26, thereby restricting rotation of the plug portion 24 relative to the socket portion 26.

In one aspect, as shown in FIGS. 3 and 4, the socket portion 26 may include a spring 54, a ramp 56, detents 58 (e.g., generally cylindrical rollers) and a sleeve 60. The detents 58 may be slidably received within one ore more apertures 62 in the body 48 of the socket portion 26. The apertures 62 may, be positioned such that the detents 58 engage the ball race 38 of the plug portion 24 when the plug portion 24 is received within the socket 50 of the socket portion 26, thereby forming a secure or locked connection between the plug portion 24 to the socket portion 26.

The spring 54 may be provided to urge the sleeve 60 and ramp 56 out of engagement with the detents 58. However, when the force of spring 54 is overcome, the sleeve 60 and ramp 56 may be advanced into engagement with the detents 58 to urge the detents 58 in the direction shown by arrows B (FIG. 3), thereby disengaging the detents 58 from the ball race 38. When the detents 58 disengage the ball race 38, the plug portion 24 may be removed from the socket 50 of the socket portion 26.

The quick-disconnect 20 may be selected from quick-disconnects commercially available from suppliers, such as Part No.: 801-70004 available from Sweet Manufacturing Inc. of Kalamazoo, Mich.

As shown in FIG. 1, a support housing 64 may be provided for supporting the drive 12 relative to the tote 14. The drive 12 may be connected to the support housing 64 by screws 66. The support housing 64 may be releasably connected to the tote 14 by any available means. In one aspect, the housing 64 may be releasably connected to the tote 14 by engaging locking lugs 68 that extend from the tote 14, through an opening 70 in the housing 64, with locking wedges 72 positioned on a bottom surface 74 of the housing 64, thereby tightly securing the bottom surface 74 of the housing 64 between the locking lugs 68 and the tote 14.

Accordingly, a user may connect the drive 12 to the mixing shaft 16 by positioning the drive 12 over the tote and engaging the socket portion 26 of the quick-disconnect 20 with the plug portion 24 of the quick-disconnect 20, wherein, in one aspect, the socket portion 26 is fixedly connected to the output shaft 22 of the drive and the plug portion 24 is fixedly connected to the mixing shaft 16. The detents 58 of the socket portion 26 may engage the ball race 38 of the plug portion 24, thereby securing or locking the socket portion 26 relative to the plug portion 24. The support housing 64 may be rotated relative to the tote 14 such that the locking lugs 68 on the tote 14 engage the locking wedges 72 on the housing 64.

The assembly 10 may be disconnected by rotating the support housing 64 relative to the tote 14 such that the locking lugs 68 disengage the locking wedges 72 and the bottom surface 72 of the housing 64. When the housing 64 is disconnected from the tote 14, a user may lift the sleeve 60 on the socket portion 26 against the bias of the spring 54 to urge the ramp 56 into engagement with the detents 58, thereby moving the detents 58 out of engagement with the ball race 38 on the plug portion 24. When the detents 58 have disengaged the ball race 38, the plug portion 24 may be separated from the socket portion 26.

Although various aspects have been shown and described, modifications may occur to those skilled in the art upon reading the specification. The public is hereby placed on notice that any patent that may issue on this application includes such modifications and is limited only by the scope of the claims.

What is claimed is:

1. A quick-disconnect mixer drive system comprising:
a drive adapted to be mounted on a mixing tank, said drive having an output shaft;
a first quick-disconnect coupling component connected to said output shaft; and
a second quick-disconnect coupling component adapted to be mounted on a mixing shaft of an associated mixing tank, said second quick-disconnect coupling component being shaped to engage said first quick-disconnect coupling component to transmit both clockwise and counterclockwise torque from said output shaft to said mixing shaft and resist relative longitudinal movement between said first and second quick-disconnect coupling components.

2. The quick-disconnect mixer drive system of claim 1 wherein said first quick-disconnect coupling component includes a socket and said second quick-disconnect coupling component includes a plug.

3. The quick-disconnect mixer drive system of claim 2 wherein said plug includes at least one substantially longitudinally extending spline and said socket includes at least one complementary groove shaped to receive said spline, wherein said spline and said groove engage to restrict relative rotation between said socket and said plug, thereby permitting torque to be transmitted from said output shaft to said mixing shaft in both a clockwise and a counterclockwise direction.

4. The quick-disconnect mixer drive system of claim 3 wherein said socket includes at least one detent and said plug includes a race shaped to receive said detent, thereby locking said socket and said plug together to prevent relative longitudinal movement therebetween.

5. The quick-disconnect mixer drive system of claim 4 wherein said socket includes a socket body and detent sleeve slidably mounted on said socket body and shaped to retain said detent within said race when said sleeve is positioned at a locking location on said socket body, and to allow said detent to move radially outwardly from said race when said sleeve is displaced to a release location.

6. The quick-disconnect mixer drive system of claim 5 wherein said detent is a roller detent.

7. The quick-disconnect mixer drive system of claim 5 wherein said socket includes a spring mounted on said socket body for urging said detent sleeve to said locking location.

8. The quick-disconnect mixer drive system of claim 1 further comprising a support housing connecting said drive to an associated mixing tank.

9. The quick-disconnect mixer drive system of claim 8 wherein said support housing includes an opening shaped to receive an associated mixer shaft and said plug therethrough and a plurality of locking wedges; and a plurality of locking lugs mounted on an associated mixing tank and shaped to engage said locking wedges to form a locking taper therewith, thereby retaining said support housing on an associated mixing tank.

10. The quick-disconnect mixer drive system of claim 1 further comprising a packing box assembly including a packing follower; a return spring seated on said packing follower; and a thrust bearing positioned between said return spring and said second quick-disconnect coupling component.

11. The quick-disconnect mixer drive system of claim 10 further comprising a collar mounted on said mixing shaft and spaced from said packing box assembly to provide a limit of travel of said mixing shaft relative to said packing box assembly.

12. The quick-disconnect mixer drive system of claim 1 wherein said drive is a motor.

13. A method for engaging a quick-connect mixer drive system comprising the steps of:
providing a drive adapted to be mounted on a mixing shaft of an associated mixing tank, said drive includes a support housing, a output shaft, a first quick-disconnect coupling component mounted on said output shaft, and a second quick-disconnect coupling component adapted to be mounted on said mixing shaft;
providing said second quick-disconnect coupling component being shaped to engage said first quick-disconnect coupling component to transmit both clockwise and counter-clockwise torque from said output shaft to said mixing shaft and resist relative longitudinal movement between the first and second quick-disconnect coupling components;
lowering said first quick-disconnect coupling component onto said second quick-disconnect coupling component;
engaging said first quick-disconnect coupling component and said second quick-disconnect coupling component; and
rotating said support housing in a counter-clockwise direction to engage at least one locking taper.

14. The method of claim 13 further comprising the steps of:
rotating said support housing in a clockwise direction to disengage said locking taper;
disengaging said first quick-disconnect coupling component and said second quick-disconnect coupling component; and
lifting first quick-disconnect coupling component from said second quick-disconnect coupling component.

15. A quick-disconnect mixer drive system comprising:
a plug portion adapted to be mounted on a mixing shaft of an associated mixing tank, wherein said plug portion includes at least one substantially longitudinally extending spline;
a drive adapted to be mounted on a mixing tank, said drive having an output shaft; and
a socket portion connected to said output shaft, said socket portion includes at least one complementary groove shaped to receive said spline, wherein said spline and said groove engage to restrict relative rotation between said socket portion and said plug portion, thereby permitting torque to be transmitted from said output shaft to said mixing shaft in both a clockwise and a counterclockwise direction.

16. The quick-disconnect mixer drive system of claim 15 wherein said socket portion includes at least one detent and said plug portion includes a race shaped to receive said detent, thereby locking said socket portion and said plug portion together to prevent relative longitudinal movement therebetween.
